(19) United States
(12) Patent Application Publication
(10) Pub. No.: US 2014/0358578 A1
(43) Pub. Date: Dec. 4, 2014

(54) SYSTEM AND METHOD FOR COMPARING PHARMACEUTICAL PRICES AND MEDICATION UTILIZATION

(71) Applicant: AMERICAN PHARMACOTHERAPY, LLC, Windermere, FL (US)

(72) Inventor: Richard Jude Ptachcinski, Windermere, FL (US)

(73) Assignee: AMERICAN PHARMACOTHERAPY, LLC, Windermere, FL (US)

(21) Appl. No.: 14/293,389

(22) Filed: Jun. 2, 2014

Related U.S. Application Data
(60) Provisional application No. 61/829,677, filed on May 31, 2013.

(51) Int. Cl. G06Q 50/22; G06Q 30/06

(52) U.S. Cl. CPC G06Q 50/22; G06Q 30/0629
USPC 705/2

(57) ABSTRACT

A system and method for comparing pharmaceutical prices and mediation utilization that provides separate databases containing (i) client pharmaceutical wholesaler and non-wholesaler purchase data, (ii) pharmaceutical compendia information, (iii) client pharmaceutical contract information, (iv) client organizational profile information, and (v) client patient volume and acuity data; and a processor in communication with the databases that (i) uploads the data and information from the databases into an input module that standardizes, validates and merges the data and information, (ii) processes the data and information from the input module by performing pricing and utilization analyses on the information and generating savings opportunities information, and (iii) formats the savings opportunities information and generates and pricing and utilization reports. A database interface for customized reporting and research analytics is also provided.

### CROSS-REFERENCE TO RELATED APPLICATIONS

This application claims priority to U.S. Provisional Application Ser. No. 61/829,677, titled SYSTEM AND METHOD OF PHARMACEUTICAL NET PRICE AND UTILIZATION BENCHMARKING AND MONITORING, filed May 31, 2013, incorporated by reference herein in its entirety.

### FIELD OF THE INVENTION

The present invention relates to the pricing and utilization patterns of pharmaceutical items. More specifically, it relates to the calculation of the net per unit price for pharmaceutical products, and the comparison of the net per unit price for identical or nearly identical products between similarly situated organizations. In addition, the invention specifically relates to the calculation of metrics that provide markers for drug utilization by a health care organization. The metrics for utilization include purchases, doses, days of therapy or treatment courses for pharmaceutical products, classes of pharmaceutical products or similarly grouped pharmaceutical products.

### BACKGROUND OF THE INVENTION

Rising costs and shrinking reimbursement is an ongoing challenge for healthcare providers and administrators. Pharmaceutical costs represent approximately 10% of healthcare costs and are frequently a source of scrutiny from consumers, healthcare administrators and government agencies. Cost transparency within the pharmaceutical market continues to be a stated goal that has not been achieved. This lack of transparency places purchasers at a competitive disadvantage when purchasing or negotiating contracts for pharmaceuticals. This results in higher prices for pharmaceutical products being paid by hospitals and other healthcare providers, insurers, government payers and ultimately consumers.

A number of surrogate price metrics exist within the pharmaceutical market. These metrics include, but are not limited to: Average Wholesale Price (“AWP”), Wholesale Acquisition Cost (“WAC”), Maximum Allowable Cost (“MAC”), Average Sales Price (“ASP”), Average Manufacturer Price (“AMP”), Federal Upper Limit (“FUL”), Widely Available Market Price (“WAMP”) and Actual Acquisition Price (“AAC”). These price metrics are either published values established by pharmaceutical suppliers and/or listed in pharmaceutical compendia such as the Red Book, First-Data-Bank and/or MediSpan®, which are data source providers that provide drug information related services and monitor current drug information. All of the price metrics named above have significant flaws in that they are an artificially established value from the suppliers; there is a significant delay between the date when the price was available and the published price and/or the impact of rebates is not included in the prices. Therefore, none of the available metrics are able to accurately calculate the net cost of a pharmaceutical product to a health care organization. Because of these flaws, none of the available price metrics provides a timely and accurate source of pharmaceutical pricing data. The end result of these flaws is that it is not possible for hospitals or other health care providers to know the range of market competitive prices and thus they are unable to effectively negotiate with suppliers for lower prices.

The current purchasing process for pharmaceuticals involves six main parties: (1) consumers/patients; (2) hospitals/health systems, pharmacies and other pharmaceutical purchasers; (3) private and government insurers; (4) drug wholesalers; (5) group purchasing organizations (“GPO”), and (6) pharmaceutical manufacturers. The invention directly focuses on pricing and utilization within hospitals/health systems, drug wholesalers, GPO's and pharmaceutical manufacturers. The processes and principles of the invention can be applied to any purchasing segment within the pharmaceutical supply chain.

According to the Robinson-Patman Price Discrimination Act, it is illegal for a vendor to charge similarly situated, competing buyers different prices for like commodities where the price difference may negatively affect competition. However, in the case of Abbott Laboratories v. Portland Retail Druggist Association, the U.S. Supreme court ruled that manufacturers could offer special discounts for not-for-profit purchasers for their own use. This resulted in the evolution of the class-of-trade system as a method to categorize customers by type of business and/or types of patients treated. The definitions of classes of trade are established by the manufacturers who control eligibility for discounts. Some manufacturers allow class-of-trade or market segmentation to occur at the business unit level such as acute care, non-acute care, retail and long term care. Determining and communicating classes of trade is a common source of errors in when determining prices of pharmaceutical products.

The Health Resources and Services Administration (“HRSA”), an agency of the U.S. Department of Health and Human Services, is the primary Federal agency for improving access to health care services for people who are uninsured, isolated or medically vulnerable. The 340B Drug Pricing Program is administered by HRSA and requires drug manufacturers to provide outpatient drugs to eligible health care organizations/covered entities at significantly reduced prices. The 340B Drug Pricing Program enables covered entities to stretch scarce Federal resources as far as possible, reaching more eligible patients and providing more comprehensive services. Eligible health care organizations/covered entities are defined in statute and include HRSA-supported health centers and look-alikes, Ryan White clinics and State AIDS Drug Assistance programs, Medicare/Medicaid Disproportionate Share Hospitals, children's hospitals, and other safety net providers. To participate in the 340B Drug Pricing Program, eligible organizations/covered entities must register and be enrolled with the 340B Drug Pricing Program and comply with all 340B program requirements. Once enrolled, covered entities are assigned a 340B identification number that vendors verify before allowing an organization to purchase 340B discounted drugs for eligible outpatients.

In addition to 340B based price discounts, eligible health care organizations/covered entities frequently are able to access special Disproportionate Share Hospital (“DSH”) discounts for acute inpatient care. These discounts are not readily available to non-DSH facilities and thus should not be used for price comparisons between DSH and non-DSH facilities. Some wholesaler contracts offer different discount rates for 340B purchases compared to non-340B purchases within the same organization. Therefore, a comparison of net per unit costs between 340B eligible facilities would provide opportunities for additional discounts for some 340B eligible facilities.

The prices and discounts offered to 340B eligible facilities are updated quarterly. These prices are kept in strict confidence among 340B eligible facilities and are not shared with non-340B facilities. Accurate price comparisons require separate analyses for 340B and non-340B facilities.

Pricing errors for pharmaceuticals contribute to added costs and work for pharmacies and other health care providers. Currently, there is no single source of data regarding pricing errors. However, all stakeholders in the pharmaceutical supply chain incur expense associated with the actual error but also workload costs associated with identifying and correcting pricing errors. It has been estimated that the rate of billing errors is relatively low, with an average of approximately 0.75%. However, a hospital with annual purchases of $20M could have $150,000 in billing errors each year.

Manufacturers of pharmaceutical products assign items a National Drug Code (“NDC”) number. NDC's are created and reported according to a unique, three-segment numbering convention. When combined, the three segments result in a unique number that identifies the drug, strength, dosage form, package size and manufacturer for every commercially available, non-compounded, prescription drug. The first segment is the Labeler code, which is assigned by the United States Food and Drug Administration (“FDA”) and identifies the pharmaceutical company that manufactured or distributed the drug. The manufacturer/distributor assigns the remaining two sets of digits to each product to define a specific set of active ingredients, strength, dosage form and package size.

Many equivalent pharmaceutical products are manufactured or distributed by different suppliers. The drug information database MediSpan® assigns products a Generic Product Identifier (“GPI”) that is a 14-character field (GPI-14), consisting of seven two digit sub-sets. The first ten digits define the generic name of the drug (GPI-10) with the remaining four digits defining the dosage/strength and route of administration. Drugs in the same GPI-14 all have the same drug, strength, dosage form and route of administration but may differ in their package size and/or manufacturer. Throughout this submission, references are made to MediSpan® and several of its proprietary data fields or terms. These references are provided as a present use example only. The reference drug compendia or data fields may be changed from time to time to enhance the functionality of the invention.

The Generic Product Packaging Code (“GPPC”) is assigned by MediSpan® to identify groups of drugs with the same GPI-14 (drug, strength, dosage form and route of administration) as well as the same package size attributes such as package size, package unit of measure, package quantity (or case quantity), and unit dose type. Purchasers may require specific package size or package type for specific circumstances such as a large stock bottle, unit dose box, or multi-dose vial. The GPPC code can be used systematically to identify groups of drugs with the same packaging. The only difference in these groups of drugs is typically the manufacturer of the product. The GPPC can be used to compare pricing for equal size products across various brand and generic manufacturers.

While most pharmaceutical products are purchased through one of several pharmaceutical wholesalers, some products are purchased directly from a pharmaceutical manufacturer or other supplier. While some of these products are assigned NDC numbers by the supplier, other products either do not have an NDC or the NDC is not available in standard pharmaceutical compendia. The lack of readily available NDC data for products purchased outside the pharmaceutical wholesaler supply chain make price comparisons for end users very challenging if not impossible.

Current practice for hospitals is to rely on suppliers such as pharmaceutical wholesalers and/or GPO's to provide guidance to pharmacy staff when making decisions regarding purchasing the lowest cost products. Unfortunately, there are inherent conflicts of interest for each of these groups because their revenues are directly proportional to pharmaceutical purchases. Because of this conflict, pharmaceutical wholesalers and GPO's also have business incentive to limit pricing transparency of pharmaceutical products. There are currently no products or services that provide unbiased price comparisons that reflect actual costs paid by purchasers in a timely manner.

Organizations that purchase pharmaceutical products are able to obtain lower prices from drug manufacturers by meeting specific contract criteria. Drug manufacturers competing for business often offer discounts based the amount of product that they purchase and the relative use of their products compared to competitors. For example, a drug company might provide a discount on a certain drug to treat a particular condition, as long as their product or grouping of products comprises a specific market share of the total amount of drugs that the hospital uses to treat that condition. The lower cost if frequently provided in the form of rebates that are credited or paid based upon purchases from a prior purchasing quarter. Because of this delay, the impact of these rebates is not reflected in pricing data provided by the wholesalers or other suppliers. Therefore, the price data provided by these sources does not represent accurate net price data leaving purchasing staff with incomplete information.

Another problem with the current process is that pharmacy purchasing staff is often unaware whether they are on-track to achieve market share tiers and discounts and thus may not take full advantage of the available discounts. Representatives from some suppliers occasionally may inform purchasing staff of their purchase history relative to market share tiers but this process is not consistent among suppliers or representatives.

The disclosed invention describes a process for collecting, standardizing, organizing, analyzing, comparing and reporting pharmaceutical purchase data in a consistent, unbiased way while maintaining confidentiality of contract terms and provisions of individual suppliers and organizations involved in the purchasing, contracting and supplying of pharmaceutical products.

The systems and methods in the present invention support purchasers of pharmaceutical products in efforts to identify market competitive pricing, determine whether the prices they are currently paying and/or negotiating are market competitive and potentially reduce the cost paid for pharmaceutical products.

While price is an important factor contributing to the cost of pharmaceuticals, another factor is utilization. The efficient, cost-effective utilization of medications is a key driver of cost and quality of care outcomes. There is no standard approach to measuring and/or comparing utilization of pharmaceuticals. An important consideration in measuring and monitoring drug utilization is the need to separate purchases of drugs that are used for the treatment of inpatients (e.g. hospitalized) from purchases of medications used in the ambulatory/outpatient setting. The need to separate these purchases is due to the different reimbursement mechanisms between inpatient and outpatient care. Hospital inpatients are typically reimbursed according to fixed reimbursement models based upon Diagnostic Related Groups (“DRG”) with the cost of medications included in the bundled payment. Most outpatient medications, above a cost threshold, are reimbursed according to a fee schedule for each drug.

The American Society of Health-System Pharmacists (“ASHP”) has a system for classifying drugs commonly used in drug utilization studies according the American Health-System Formulary Service (“AHFS”) Medication/Pharmacologic-Therapeutic Classification System. The six digit code number includes three levels of information is assigned based upon the drugs' action or use. The first two digits represent a high level of classification or anatomical group, the second digits represent the drug group and the last two digits represent the drug class. AHFS therapeutic classifications are commonly used to group drugs for clinical utilization.

The options for the prevention and/or treatment of many illnesses may include drugs that fall into different AHFS therapeutic classes. Therefore, utilization metrics should include drugs within different AHFS therapeutic classes for specific therapies.

Meaningful metrics for utilization require an appropriate adjustment for volume and the severity of illness (e.g. acuity) of patients being treated. Current methods that attempt to quantify utilization most commonly use patient day, discharges, or admissions. Some programs attempt to include an adjustment factor to account for the fact that the data includes both inpatient and outpatient purchases. This is done by calculating Adjusted Patient Day or Discharge (“APD”) where Adjusted Patient Day (or discharge)=Inpatient days (or discharges)×(hospital total gross revenue/hospital inpatient gross revenue). A flaw with this approach is that charging formulas among hospitals vary significantly. Therefore, two hospitals may have up to a ten-fold difference in gross revenue for an item costing exactly the same amount. Obtaining actual cost data for inpatient settings and outpatient settings represents an improved approach to establishing metrics for comparing the utilization of drugs in the inpatient setting.

Some clinical utilization systems are able to link drug utilization with specific patients and treatments with data derived from an electronic medical record (“EMR”). While this may provide some guidance regarding drug utilization, the data is generally difficult to extract and there are significant delays in its availability relative to the event. This lack of timeliness limits the usefulness in making meaningful changes. In addition, measuring utilization data does not account for drug product waste, expiration, or other factors that result in product loss.

In summary, flaws with existing programs that estimate drug utilization include: the fact that inpatient and outpatient purchases are often merged in the same data file; the volume adjustments do not include account for patient acuity or volume of some procedures that significantly increase the utilization of specific pharmaceuticals (e.g. Percutaneous Coronary Interventions (“PCI”)); and the fact that the calculation of Adjusted Patient Days does not accurately reflect the inpatient/outpatient ratio of most products purchased by hospitals.

Therefore, there is a need for a method to provide accurate and timely price data to pharmaceutical purchasers that can be used to monitor prices and support purchasers in achieving market competitive prices. In addition, there is a need for a method to provide timely, volume and acuity adjusted drug utilization data to support providers and administrators in their efforts to provide cost-effective care to patients.

### SUMMARY OF THE INVENTION

There is a need in the art for methods and systems to analyze actual purchase data for pharmaceutical products in a consistent, manner that enables purchasers to identify strategies to decrease their cost of pharmaceutical products through improved contract negotiations, selecting alternative equivalent products or implementing strategies to reduce the utilization of high cost drug therapies.

According to the embodiment of the invention, there are disclosed methods for collecting actual purchase data from health care organizations, standardizing the inputs from different organizations into a consistent, reproducible format; organizing the purchase data in such a manner to enable the creation of metrics; analyzing the purchase data and creating reports that maintain confidentiality of proprietary data; segregating by class of trade or 340B status and providing results in a readily useable format that can be used by organizations to improve contracting, purchasing and utilization of pharmaceutical products.

One disclosed method includes the collection, organization, standardization and analysis of data including: the average price per NDC paid per month; the extended cost divided by the number of units purchased during a time period; discounts provided by wholesalers; GPO's and manufacturers; and rebates based upon purchase volume and/or market share tiers. The invention includes a method to standardize and organize data from pharmaceutical purchases made outside of the wholesale supply chain to be compared with other similar or equivalent products.

The invention also discloses a method for calculating the utilization of pharmaceutical products per unit volume and/or the severity of illness (e.g. acuity) of the population being treated.

According to one aspect of the invention, the method may further include conducting a series of checks to identify potential problems with the integrity, format or quality on the data submitted by health care providers or other entities. The invention includes requirements for data submission with reference to format of submission, data elements, and requirements for separation of data based upon the location of treatment where pharmaceutical products are administered or dispensed; class-of-trade and/or eligibility for 340B Drug Program price discounts. According to another aspect of the invention price and utilization data may be electronically stored in order to merge with published sources of data; to categorize within similarly situated organizations, classes of trade or other groups; and to perform comparisons between users of and/or subscribers to the invention.

According to one aspect of the invention, a method of standardizing and organizing products that do not have a readily available NDC, GPI-14 or GPPC into a format that can be grouped and compared with other similar or equivalent products is described.

According to another embodiment of the invention, the pharmaceutical products are grouped based upon NDC, GPI-14 and GPPC for price comparisons by product, class-of-trade, and eligibility for 340B or DSH price discounts.

The invention includes the preparation and distribution of reports and information tables that compares prices by NDC, GPI-14 and GPPC for similarly situated organization. Pricing data is reported as aggregate percentiles in order to protect the confidentiality of exact prices and/or contract terms. Net prices are compared to other price metrics such as AWP and WAC and reported as a ratio.

According to another aspect of the invention, metrics related to the utilization of specific GPI-10 therapeutic classes and/or other groupings of drugs are developed. The metrics are adjusted for volume using parameters including but not limited to, inpatient hospital days, discharges, specific procedures, diagnoses and days of treatment for specific diseases. According to another aspect of the invention, the utilization metrics are adjusted for the severity of illness or patient acuity using Case Mix Index (“CMI”) and/or other parameters of patient acuity.

The invention includes estimating potential saving that could be realized if the purchases of a drug, therapeutic class of drugs or other grouping of drugs was at or below the median or other statistical metric for volume adjusted cost for similarly situated organizations.

The invention includes a method for tracking and trending changes in drug utilization over time. The frequency of reporting enables the user to rapidly identify potential changes in utilization and target specific drugs or therapies for future trending. The longitudinal tracking can be used for routine monitoring of utilization and/or to measure the impact of programmatic changes in drug utilization and pricing.

The invention provides the ability of users to identify utilization trends for new drugs or therapies as they enter the market.

### BRIEF DESCRIPTION OF THE DRAWINGS

For the present invention to be easily understood and readily practiced, the invention will now be described, for the purposes of illustration and not limitation, in conjunction with the following figures, wherein:

FIG. 1 is a flow diagram depicting the prior art methods by which pharmaceutical products are ordered and purchased;

FIG. 2 is a flow diagram depicting one embodiment of the present invention for analyzing pharmaceutical, contract, purchase and organizational profile data and generating reports that support users in efforts to obtain products at the lowest possible price and identify opportunities to reduce drug utilization;

FIG. 3 is a table with an example of a data input including the data fields that are entered into the database from pharmaceutical wholesalers;

FIG. 4 is a table depicting sample calculations that are used for adjusting pharmaceutical purchases for volume and patient acuity;

FIGS. 5a and 5b, together, are a flow diagrams depicting an exemplary method of the present invention for standardizing, validating, and categorizing pharmaceutical purchase and patient volume data, and pharmaceutical contracts;

FIG. 6 is a flow diagram depicting an exemplary method to calculate gross cost per unit, qualifying discounts and rebates, net costs per unit, acuity adjusted costs and benchmark pricing segmented by Class of Trade;

FIG. 7 is a table depicting a sample price comparison report;

FIG. 8 is a table depicting a sample price parity report for two hospitals that are part of the same integrated delivery network;

FIG. 9 is a table depicting a sample purchasing opportunity report for equivalent products that are available from different suppliers;

FIG. 10 is a table depicting a sample drug utilization savings opportunity report;

FIG. 11 is a table depicting a sample longitudinal drug utilization report; and

FIG. 12 is a table depicting a sample drug utilization savings opportunity report within a single therapeutic class of drugs.

### DETAILED DESCRIPTION OF THE INVENTION

The present invention describes a process to collect, standardize, organize, analyze, compare and report pharmaceutical purchase data in a consistent, unbiased way while maintaining confidentiality of contract terms and provisions of individual suppliers and organizations involved in the purchasing, contracting and supplying of pharmaceutical products.

Definition of terms used herein are as follows:

Adjusted patient days: An aggregate figure reflecting the number of days of inpatient care, plus an estimate of the volume of outpatient services, expressed in units equivalent to an inpatient day in terms of level of effort. The figure is derived by first multiplying the number of outpatient visits by the ratio of outpatient revenue per outpatient visit to inpatient revenue per inpatient day. The product (which represents the number of patient days attributable to outpatient services) is then added to the number of inpatient days. Originally, the purpose of this calculation was to summarize overall productivity and calculate a unit cost that would include both inpatient and outpatient activities.

Admissions: The number of patients, excluding newborns, accepted for inpatient service during the reporting period; the number includes patients who visit the emergency room and are later admitted for inpatient service.

Average daily census: The average number of people served on an inpatient basis on a single day during the reporting period; the figure is calculated by dividing the number of inpatient days by the number of days in the reporting period.

Case Mix Index (“CMI”): The CMI of a hospital reflects the diversity, clinical complexity and the needs for resources in the population of all the patients in the hospital. The CMI value of a hospital can be used to adjust the average cost per patient (or per day) for a given hospital relative to the adjusted average cost for other hospitals by dividing the average cost per patient (or day) by the hospital's calculated CMI. The adjusted average cost per patient would reflect the charges reported for the types of cases treated in that year. If a hospital has a CMI greater than 1.00, their adjusted cost per patient or per day will be lower and conversely if a hospital has a CMI less than 1.00, their adjusted cost will be higher.

Days of Therapy: Days of Therapy (“DOT”) is typically used as a metric for antibiotic stewardship. DOTs are measured as the number of days a patient is on a therapy regardless of dose.

Defined Daily Dose: The assumed average maintenance dose per day for a drug used for its main indication in adults. Defined Daily Dose (“DDD”) metrics are established and maintained by the World Health Organization (WHO). It should be emphasized that the defined daily dose is a unit of measurement and does not necessarily reflect the recommended or Prescribed Daily Dose. Doses for individual patients and patient groups will often differ from the DDD and will necessarily have to be based on individual characteristics (e.g. age and weight) and pharmacokinetic considerations. The DDD provide a fixed unit of measurement independent of price and dosage form (e.g. tablet strength) enabling the researcher to assess trends in drug consumption and to perform comparisons between population groups.

DSH discounts: In addition to 340B based price discounts, eligible 340B health care organizations/covered entities frequently are able to access special Disproportionate Share Hospital (“DSH”) discounts for acute inpatient care. These discounts are not readily available to non-DSH facilities and thus should not be used for price comparisons between DSH and non-DSH facilities.

GPI-14: MediSpan's Generic Product Identifier (“GPI”) defined pharmaceutically equivalent drug products that are identical in terms of active ingredient, route of administration, dosage form, and strength or concentration. GPI does not take into consideration package size or package type or manufacturer or brand/generic status. GPI categorizes drug products by a hierarchical therapeutic classification scheme. This hierarchal approach allows users to sort drugs by GPI number into therapeutic classes.

GPI-10: GPI classification system is divided into 7 two digit couplets each providing increasingly more specificity regarding drug products. GPI-10 is the first 5 couplets or 10 digits of the GPI-14. The GPI-10 designates the specific drug and salt but does NOT define the dosage form or strength or other attributes.

GPPC: The Generic Product Packaging Code (“GPPC”) is assigned by MediSpan to identify groups of drugs with the same GPI-14 (drug, strength, dosage form and route of administration) as well as the same package size attributes such as package size, package unit of measure, package quantity (or case quantity), unit dose type.

Hospital discharge: A discharge is the release of a patient who has stayed at least one night in hospital. It includes deaths in hospital following inpatient care.

Inpatient Days: The number of adult and pediatric days of care, excluding newborn days of care, rendered during the entire reporting period.

Length of Stay: Length of Stay (“LOS”) refers to the average number of days a patient stays at the facility.

National Drug Code (“NDC”): A unique 11 digit drug product identifier established by the Food and Drug Administration and manufacturers. An NDC identifies the drug, strength, dosage form, package size and manufacturer for commercially available, non-compounded, prescription drugs. The NDC number is often a key identifier used when dispensing or purchasing drugs.

For the purpose of providing an exemplary embodiment of the invention only, the systems and methods described below refer to the applicability of the methods for hospitals and health systems. The methods described can and intend to be applied to other purchasers of pharmaceutical products including but not limited to: retail pharmacies; mail-service pharmacies; specialty pharmacies; long-term-care pharmacies; closed door pharmacies; long-term-care facilities; skilled-nursing facilities; physician offices; and clinics.

It is to be understood that both the foregoing general description and following detailed description are exemplary and explanatory and are intended to provide further explanation of the disclosed invention claimed.

It is contemplated that the subject matter described herein may be embodied in many forms. Accordingly, the embodiments described in detail below are the presently preferred embodiments, and are not to be considered as limitations.

The invention involves the option of preparing statistical analyses and reports based upon any combination of data that is contained in the database. The included descriptions are exemplary and may be modified from time to time.

The present invention includes a series of computer-based processes, instructions and methods. The methods described below represent an example of the types of computers, software programs, instructions, calculations and outputs that are generated from the invention. The computer program instructions may be loaded onto a general purpose computer, special purpose computer or other programmable data processing apparatus or machine such that the instructions which execute on the computer or other programmable data processing apparatus create means or mechanism for implementing the described functions.

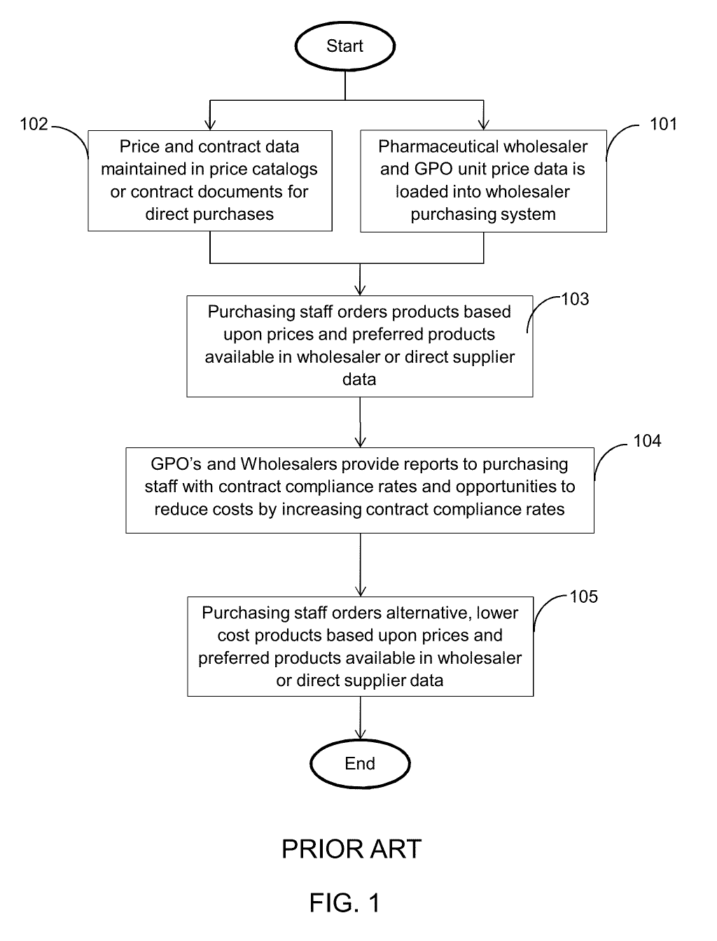

Now turning to FIG. 1 for an illustration of one example of the prior art process where pharmaceutical price and contract data is received by wholesalers from manufacturers, GPO's or health care organizations 101. Pharmaceutical price and contract data is also maintained by non-wholesaler suppliers within price catalogs based upon contracts with GPO's or health care organizations 102. Pharmacy purchasing staff uses the wholesaler purchasing systems to determine product availability, determine current prices, place orders for available products 103. Some wholesaler ordering systems include a feature that encourages the purchasing staff to place orders for preferred products. Products may be included as available or preferred on wholesaler purchasing lists based upon the preferences of the wholesaler or GPO and may not include all available products or list the lowest cost alternative as the preferred product. This results in pharmacy staff buying higher cost products when lower cost alternatives may be available in the market place.

Pharmacy purchasing staff also places orders for products that are purchased outside the wholesaler supply chain by checking the availability and price of items that are supplied directly pharmaceutical manufacturers, or other companies that do not utilize the pharmaceutical wholesaler supply chain 103. Pharmacy purchasing staff does not have a source of information to compare price information between equivalent products that are provided by these suppliers. This lack of comparative price data results in organizations paying higher prices for pharmaceutical products that ultimately is one contributor to rising healthcare costs.

Pharmaceutical wholesalers and GPO's may provide contract compliance and price opportunity reports to clients 104. While these reports to identify some opportunities to reduce costs by purchasing lower cost alternatives, these reports do not contain products and/or prices available through other wholesalers or GPO's. This lack of transparency of product availability and price data results in pharmacy purchasing staff not having sufficient data always purchase the lowest cost product.

Based upon purchase history and reports provided by wholesalers and GPO's pharmacy purchasing staff may change their purchasing habits to purchase lower cost products 105. However, as stated previously, because of the lack of market place transparency, there may be lower cost alternatives available that the purchasing staff is not aware of since they are relying on data and reports provided by the wholesaler and GPO.

In summary, the current prior art process for purchasing pharmaceutical products has several problems: 1) there is an inherent conflict of interest for pharmaceutical wholesalers, GPO's and other suppliers that prevents them from being willing to provide data on equivalent products that may be available at a lower cost than the their product portfolio; 2) contractual obligations prevent sharing of exact price data between organizations; 3) comparative price information is difficult to obtain because of several pharmaceutical classes of trade and 4) comparative price information for pharmaceutical products purchased outside the pharmaceutical wholesale supply chain is not readily available.

The present invention solves these problems by providing objective, unbiased information in a format that protects confidential data, separated by class of trade from within and outside the pharmaceutical wholesaler supply chain process.

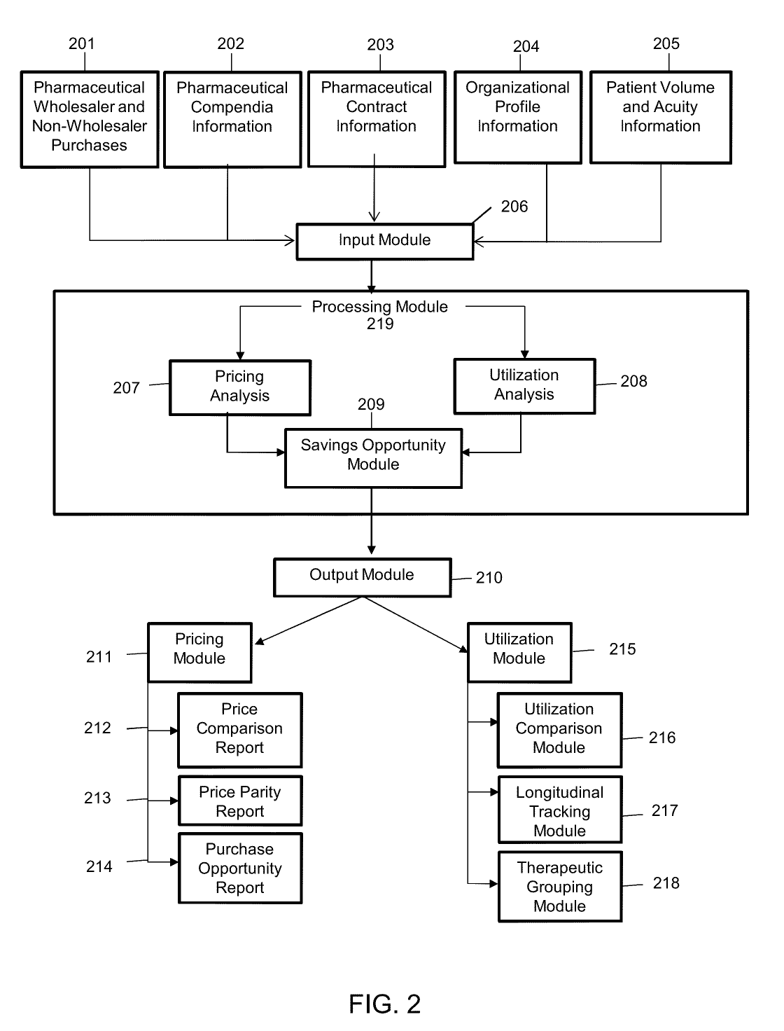

FIG. 2 shows one embodiment of the present invention for analyzing pharmaceutical, contract, purchase and organizational profile data and generating reports that support users in efforts to obtain products at the lowest possible price and identify opportunities to reduce drug utilization that corrects the problems that exist with the current process. The figure depicts an exemplary architecture for performing the disclosed methods. Such architecture may be realized by a computer, a mobile computing device, a networked computer or any other suitable processing arrangement. The architecture can be established and maintained in spreadsheets and database software such as Access, Excel, and/or any commercially available database software. The use of Access or Excel as database management and reporting tools are provided as examples for explanation purposes only. The database program used with this invention may change from time to time.

The first step involves the input of data from clients as part of an onboarding process. The onboarding involves the collection and input of wholesaler and non-wholesaler purchase and baseline account data 201, pharmaceutical compendia information 202; contract information 203; an organizational profile information 204 that is used to accurately segment facilities by bed size, class of trade, eligibility for 340B pricing and clinical services offered; and patient volume and acuity information 205. In other embodiments of the inventions, other data or information may be include, certain data or information may be combined, and certain data or information may not be included.

The data and information described above is entered into a computer database such as Access, Excel or other similar program embodied in the input module 206. The information and data points for each individual client from databases 201, 203, 204, and 205, along with pharmaceutical compendia information from database 202 are entered into the database in input module 206 and are used for grouping similarly situated organizations and grouping facilities based upon their ability to purchase drugs as a 340B entity and receive DSH price discounts. The data that is input includes, but is not limited to the following: number of licensed beds and the per month occupancy over the past 12 months (or other designated period); and information describing the type of facility such as academic, community-teaching, community, rehabilitation, psychiatric, a children's hospital, a standalone oncology center, long-term-care, physician office or other type of organization and what if any special services are provided including, pediatrics, solid organ transplant, bone marrow transplant, oncology, psychiatry, rehabilitation, and other services. The initial data input may be changed from time to time based upon market, regulatory and/or requests from clients. After the initial input process, clients report changes to their account profile on a monthly basis.

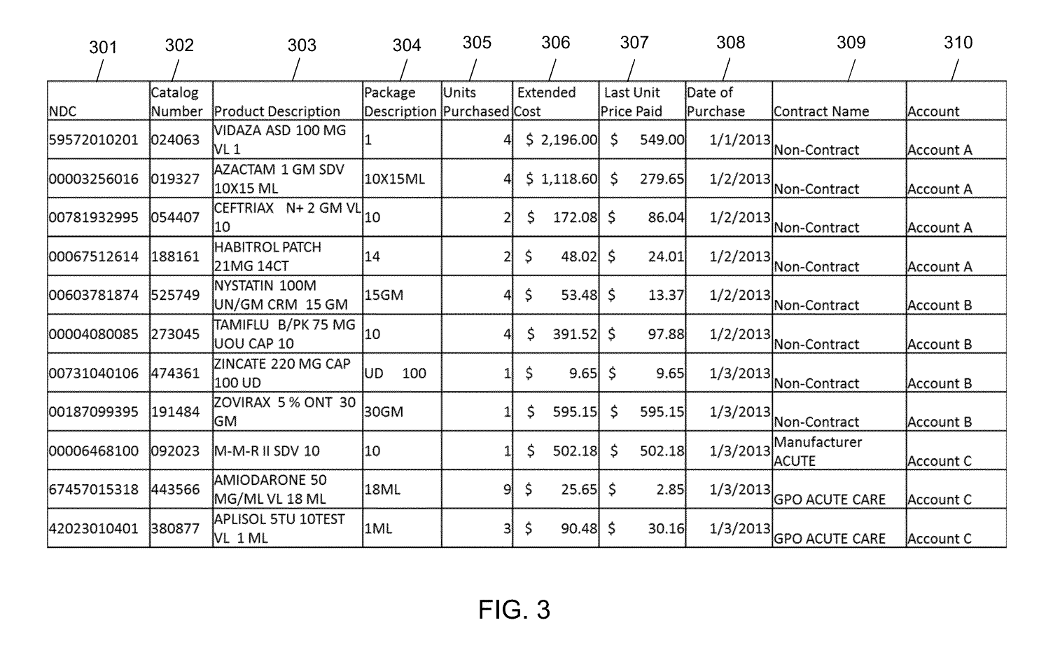

As mentioned above, Pharmaceutical purchases from wholesalers and other suppliers are collected in database 201 and input into a module or computer database 206 and can be stored on a hard drive, a server, or network of computers among other things. All purchases from pharmaceutical wholesalers are input as spreadsheets, in file formats such as Excel, CSV or txt. FIG. 3 is an example of a data input including the data fields that are entered into the database from pharmaceutical wholesalers. Data fields that are collected and entered into the database include, but are not limited to: NDC 301; catalog number 302, Product Description 303 (drug name, strength, package size and units per package); Package Description 304; units purchased (net of returns) during the period of the report 305; extended cost (units purchased×cost per unit at the time of purchase) 306; last unit price paid 307; date of purchase 308, contract name (name of the contract under which the product was purchased) 309, account name (name of the specific account within a facility purchasing the product) 310. These data fields are provided as examples and represent preferred data fields but may be changed from time to time. As part of the onboarding process, historical purchase data, going back as far as 24 months may be collected. The same data is also submitted pertaining to pharmaceutical purchases from other non-wholesaler suppliers including, but not limited to, manufacturers, repackagers and compounding pharmacies.

Referring to FIG. 2, all contracts and addenda regarding the purchasing of pharmaceutical products are also collected and entered into the database 203. Specific contracts that are requested include: primary and secondary wholesaler distribution agreements; GPO agreements and including all sub-agreements between the GPO and suppliers of pharmaceutical products on behalf of the client; direct contracts with manufacturers, suppliers and/or distributors of pharmaceutical products; contracts with manufacturers, suppliers and/or distributors of pharmaceutical products who provide product on consignment; direct contracts with manufacturers, suppliers and/or distributors of other products that are related to pharmaceuticals, including but not limited to, volatile anesthetics, blood products (e.g. hemophilia factors, albumin, IVIG). The contract data is collected and entered into the computer database in an appropriately useable electronic format for all pharmaceutical products. The contract data can include: the beginning and end date of contract; the NDC if available; catalog or item number from supplier if no NDC is available; product description, package sizes and/or units of measure, cost per unit for each contract tier if applicable, volume or market share requirements for each contract tier; discounts and/or rebates associated with each contract tier; and contract name and/or number. In connection with contract tiers, in many cases contracts discount and rebates may have tiered arrangements. If a certain market share or volume threshold is met, the contract holder moves to the next tier of the discount. Other data fields may be requested from time to time. The contract data collected during the onboarding may be changed from time to time based upon market, regulatory and/or requests from clients.

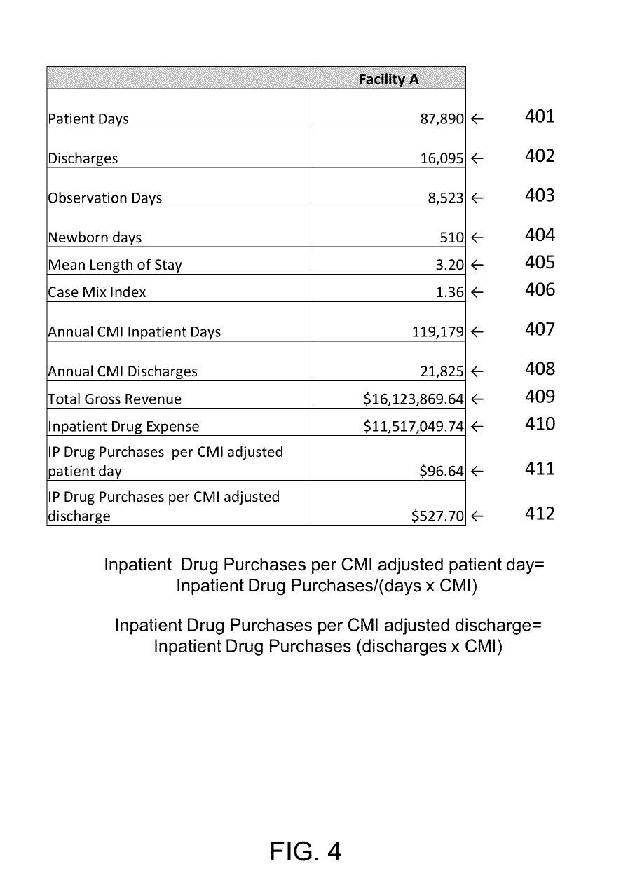

Patient volume and acuity data is input into the database 205. FIG. 4 is an example of a table that describes the inputs and calculations that performed to create the utilization benchmarks. The volume inputs include previously defined inputs such as patient days 401, discharges 402, observation days 403, newborn days 404, mean length of stay 405, case mix index 406, total gross revenue 409, and inpatient drug expense 410. The calculated metrics include annual CMI inpatient days 407, annual CMI discharges 408, inpatient drug expense per CMI adjusted patient day 411 and inpatient drug expense per CMI adjusted discharge 412. The metrics defined FIG. 4 are one example of the inputs and calculations that are used for volume and acuity adjustments and these may be changed from time to time.

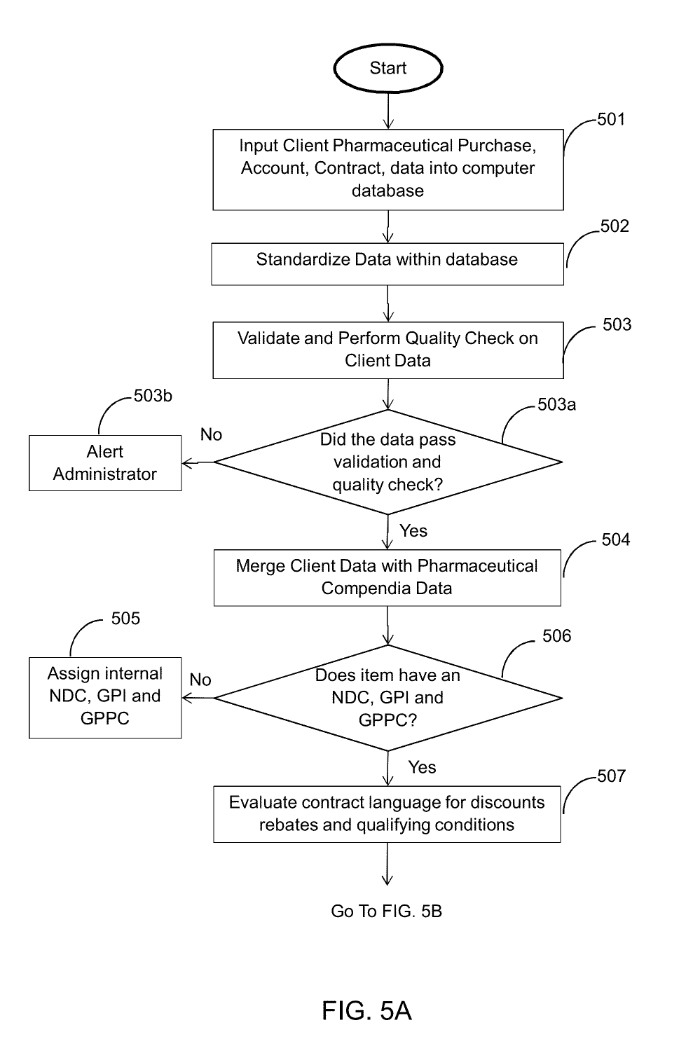

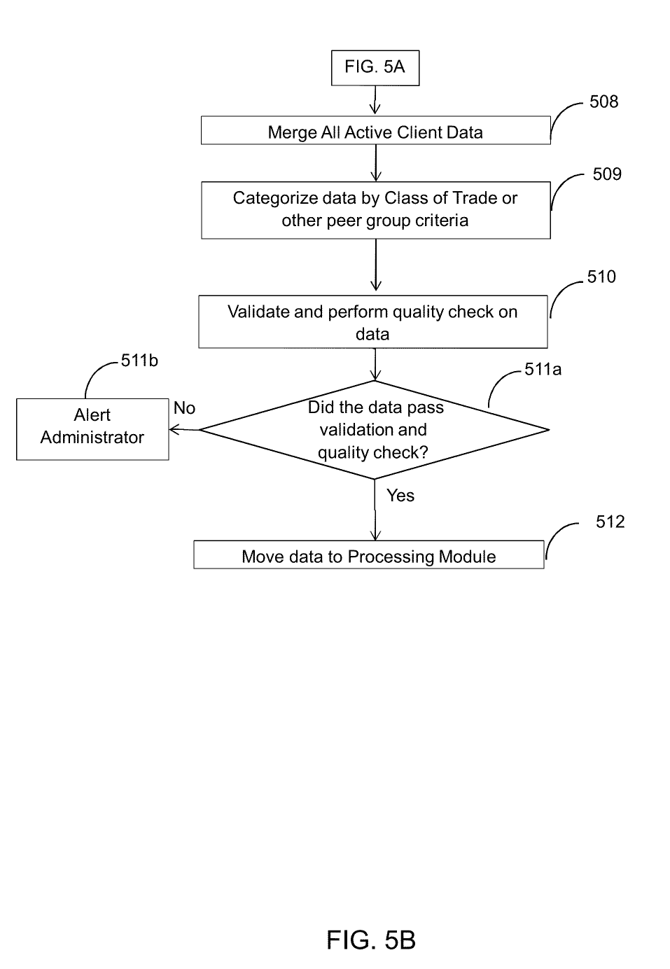

Turning to FIGS. 2 and 5a and 5b, once inputs are received, data is uploaded into input module 206. FIGS. 5a and 5b, in turn, represent the process steps within input module 206, beginning with initial uploading to computer data base 501. The present invention includes processes to manage a variety of data layout from clients and pharmaceutical suppliers. Data in various formats from all suppliers and clients is standardized into consistently formatted data tables that include the same columns, digital formats, layouts and calculation formulas 502. The standardization enables inputs to be systematically compiled and loaded into a computer database. The standardization process can also include organizing accounts, contract terms, and other data elements into standardized categories that can be compared and processed with other client data. For example, a client may describe an account as an outpatient oncology clinic, but the process of the invention may determine that this account should be classified as an outpatient infusion clinic based on the drugs purchased and information obtained during the onboarding interview.

A quality check 503 is completed to identify potential errors that may have occurred during file transfer or standardization process. Each data submission undergoes analysis for missing data fields. The invention also involves a quality check of submitted price data 503. If the data passes the validation and quality check 503a, then the merge step 504 is executed. However, any item with a ≧25% unit price difference (for example) compared to the previous month for the same client does not pass the validation and quality check 503a and is reviewed by a pharmacist or an administrator 503b. Specific thresholds and processes triggering additional research may be modified over time. If a data integrity issue is identified, it is investigated and rectified by a pharmacist or administrator. If the data is deemed to be valid, it is included in the database. The pharmacist involved in the analysis documents the analysis, findings and outcomes of all investigations. Record counts and purchase totals and other validation processes are maintained throughout the process to ensure proper accounting.

A merge 504 of the data submission with a standard pharmaceutical compendium such as MediSpan® is completed in order to establish additional drug data elements such NDC, GPI-14, GPPC, AHFS classification and other product attributes. The data quality analysis also includes a confirmation of matches between package sizes and purchase units for each item by comparing to the compendia. If missing data fields or mismatches are identified, the discrepancies are investigated and the data are corrected and/or a conversion crosswalk is created.

A database of pharmaceutical items that are not cataloged in the drug compendia such as MediSpan® is created, updated and maintained as described below. All purchase data is reviewed 506 to determine if they have a manufacturer assigned NDC in the drug compendia. If items are submitted to the database that do not have an NDC in the drug compendia, the internal database is systematically reviewed using supplier item numbers to determine if this product is listed in the internal database. If so, it is assigned an internally created item number and merged into the internal database. If the item is not yet entered in the internal database, the pharmacist manually assigns 505 the item an internal item number that is used for categorizing and tracking metrics. If the labeler has a five digit code that has been assigned by the FDA, that same code is used when assigning an internal item number. A unique item and package number is then assigned to the product using a similar numerical sequencing as manufacturer NDC's. The pharmacist reviews the item description manually and the internal number is assigned a GPI-14 and GPPC code when an appropriate match is available. Any item that does not have a supplier NDC and undergoes the GPI-14 and GPPC assignment process is reviewed and approved by a pharmacist. If at any subsequent time a labeler NDC is made available, the database is updated to include the labeler assigned NDC number.

Contract language and client submitted information is reviewed 507 to establish rebates, discounts and qualifying conditions that must be met to obtain these rebates and discounts. This information may include but is not limited to market share thresholds and drug market baskets.

The present invention then merges all data and information inputs from all clients—in particular, client data and information from databases 201 and 203-205—into a standardized format 508 for further analysis. The confidentiality of data and information specific to each client is maintained in this process step. Price files in the merged data set are categorized 509 by class of trade, 340B or DSH eligibility, organizational size or other parameters that may be identified as important or requested by users. The aggregated price data by class of trade is validated a second time 510 by flagging all items that are below, for example, the 5^{th} percentile and above the 95^{th} percentile within each class of trade, whereby the data does not pass the validation and quality check 511a and it is reviewed by a pharmacist or an alert administrator 511b. The validation process 503 assesses monthly changes within the same client's data, while the validation process 510 compares a client's monthly data to percentile benchmark data. The validation process 503 and 510 may include, but not be limited to, reviewing data input fields for potential unit or package size errors. Individual clients may be contacted if variances or discrepancies cannot be explained. Only validated data is included in the comparison database. Following the completion of the validation steps the merged data sets move to the processing module 512, which is shown as module 219 in FIG. 2. The process steps included in input module 206 can vary and include additional process steps in other embodiments of the invention. In addition, other embodiments of the invention can combine or eliminate certain of the process steps.

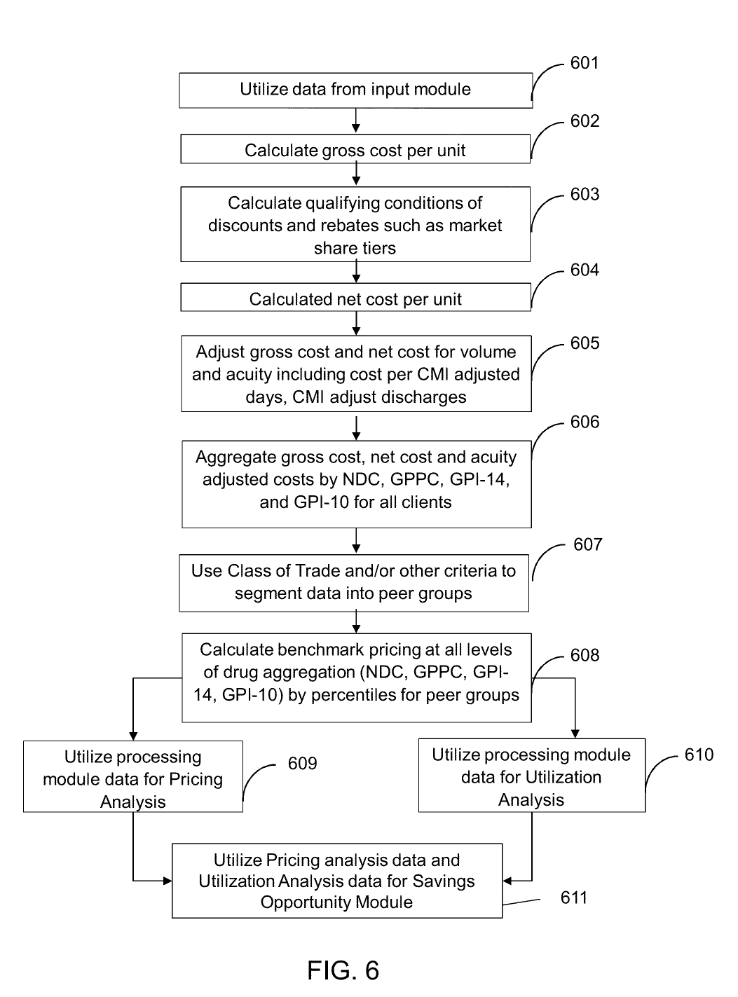

The steps of the processing module 219 are shown in FIG. 6 for one embodiment of the invention. Again, process steps can vary in other embodiments. The processing module utilizes the merged data inputs from all clients 601. Gross cost per unit is calculated by dividing the extended cost purchased by the units purchased for client over a given time period 602. Calculations are performed to assess qualifying conditions for rebates and discounts 603. Qualifying conditions may include but are not limited to meeting market share thresholds for a market basket of drugs. Rebate and discount tiers are also determined. The rebates and discounts are applied to gross costs per unit to calculate the net cost per unit 604. Both net and gross cost are adjusted for patient volume and acuity by calculating the cost per CMI adjusted day or cost per CMI adjusted discharge 605. It is necessary to aggregate costs per unit at different drug levels such as NDC, GPPC, GPI-14 and GPI 10 606. Costs are aggregated by dividing the sum of the extended purchases by the sum of the quantity purchases for the group of drugs. Once these calculations are complete the purchase data are segmented by Class of Trade, inpatient and outpatient, 340B eligibility and other criteria to create peer groups 607 to compare pricing and utilization. Benchmark prices at various percentiles such as 10^{th}, 25^{th},50^{th}, and 75^{th} are calculated for each peer group 608. Benchmark prices include gross costs per unit, net cost per unit, and acuity adjusted cost per unit. The benchmark price data next moves to the pricing analysis 609 (step 207 in Figure. 2), which focuses on identifying opportunities to purchase identical or therapeutically equivalent products by lowering purchase prices. The pricing analysis identifies opportunities to reduce gross cost and/or increase rebates and discounts. Client can realize savings by changing suppliers, negotiating for better prices, or substituting to therapeutically equivalent products or a combination of these strategies. The benchmark price data also moves to the utilization analysis 610 (step 208 in Figure. 2), which focuses on identifying opportunities to utilize drugs more efficiently. More specifically, utilization analysis 208 analyzes and categorizes pharmaceutical purchase data in a manner that creates metrics to quantify the utilization of individual items or groups of items based on their use in the prevention and/or treatment of specific medical conditions. The utilization analysis identifies scenarios where clients are utilizing individual drugs and therapeutic groups of drugs that cost more per patient than peer benchmarks. These scenarios represent opportunities for the client to engage in and track clinical pharmacy practice initiatives to optimize drug utilization.

Referring to FIG. 2, the data from the pricing analysis 207 and utilization analysis 208 is entered into the savings opportunity module 209. The savings opportunity module integrates the pricing and utilization analyses, then identifies and quantifies the savings opportunities. A pharmacist reviews each opportunity and performs any additional research that is required to vet the opportunity. The standardized data and derived opportunities advance to the output module 210. Output module 210, in turn, generates standard and custom pricing module reports 211 and utilization module reports 215.

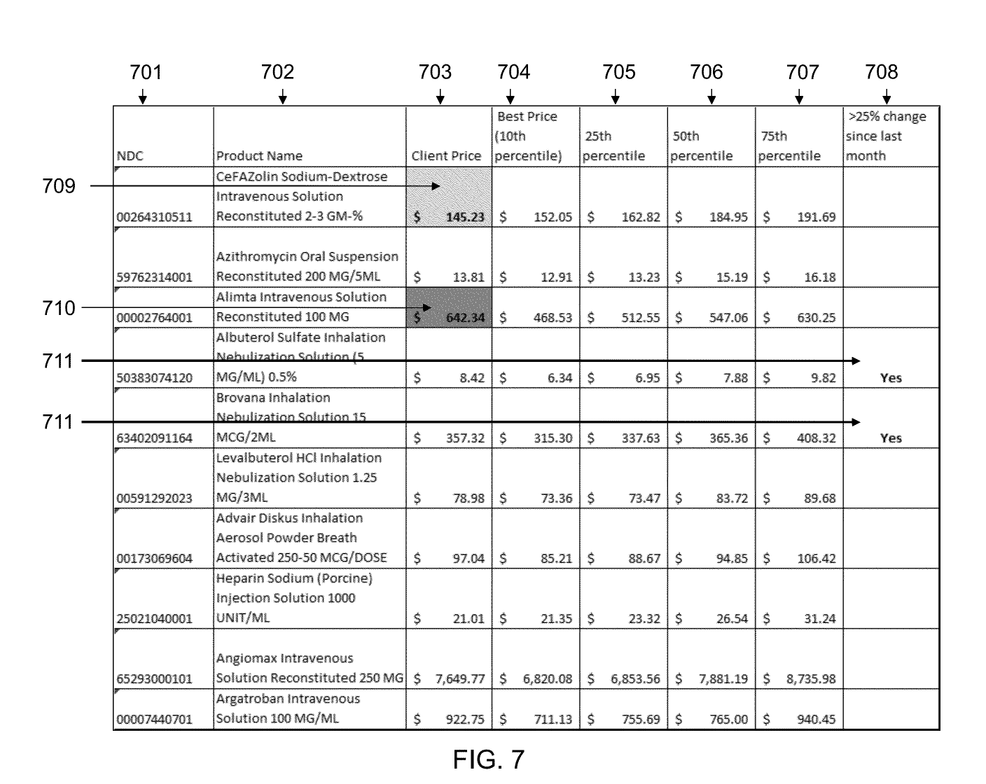

Examples of reports generated from the pricing module 211 are provided in FIGS. 7-9. These reports, as well as the reports generated from utilization module 215, illustrate the preparation and delivery capability of the present invention, wherein the report can be delivered via electronic methods such as e-mail or internet. These reports can be combined in other embodiments of the invention, and other reports can be added. In addition, the reports provided by the present invention can be generated on a monthly basis or other frequency for each client. Output report are accessed by or transmitted to the client in an electronic, secure, and convenience format which may include but is not limited email transmission, secure web portal, file transfer protocol (“FTP”), and/or file sharing service using a secure username and password. In addition to receiving standard or customized output reports, the invention includes a dynamic interface that allows clients to research and analyze the standardized data in the pricing and utilization analysis. Standard reports are available for printing and exporting on demand by the client. The client is able to customize various reporting parameters to create customized reports. Variable parameters include but are not limited to selection of specific drugs or groups of drugs by therapeutic category or other drug description, selection of different time ranges by year and month, selection of peer group criteria according to account criteria such as hospital size, DHS eligibility, inpatient/outpatient status, wholesaler etc. Clients can move from higher level drug groups such as AHFS to more detailed drug groups such as GPI-10, GPI-14, GPPC down to NDC level. Client can select reports as single points in time or as trends over a time period. The client can customize the time range and interval such as monthly, quarterly or year. The dynamic interface allows the user to customize the reports and data views using filters, drop down menus and other input process using a web interface or other dynamic database interface tool. The specific item pricing information accessible to any client is limited to their own organization and clients are not able to access data and/or aggregate statistical information for clients outside their class of trade or 350B/DSH groups. For example, non-340B/DSH eligible clients will not have access to 340B/DSH drug prices or other information from 340B/DSH eligible organizations.

FIG. 7 shows a sample Price Comparison Report 212. The report 212 includes client specific pricing for each NDC 701 and product 702 generated by the analysis and calculations in the Pricing Module 211 The report 212 includes a comparison of the client price 703, the 10^{th} 704, 25^{th} 705, 50^{th} 706, and 75^{th} 707 percentile for each item for similarly situated facilities and classes of trade. The report 212 also includes a column 708 that notes any items with a change of >25% since the prior month, with an indication of this change shown in entries 711. In addition, as shown in entry 709, a color coding of items is made where client cost is at or below 10^{th} percentile (which is be highlighted in green in the actual report), and a color coding of items is shown in entry 710 where client cost is at or above the 75^{th} percentile (which can be highlighted in red in the actual report). This report supports pharmacy purchasing staff in identifying opportunities to lower costs through contract negotiations and/or purchasing lower cost, equivalent products.

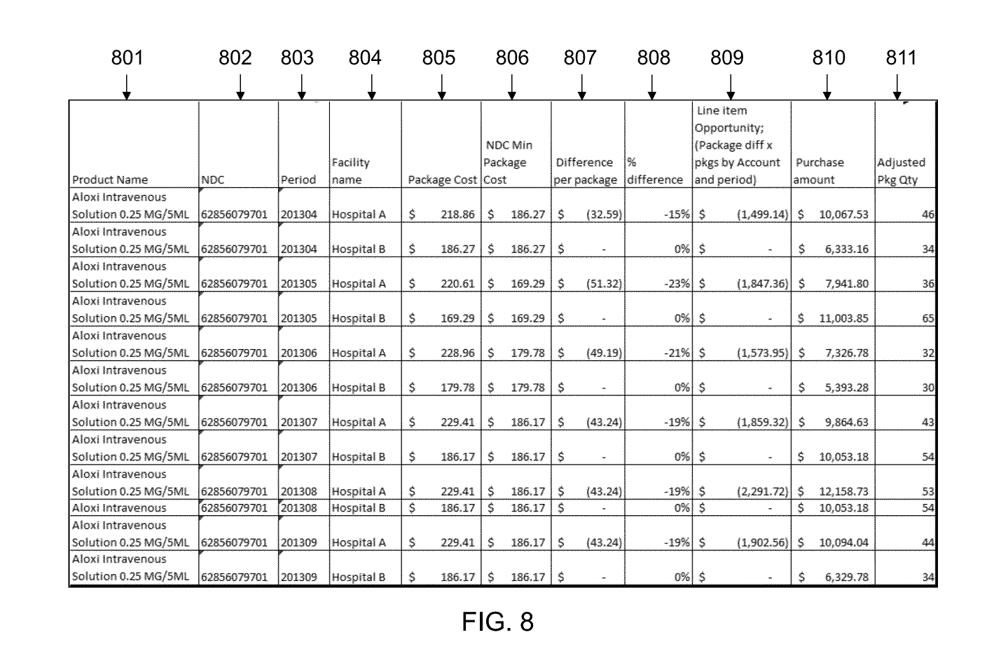

Since contracting departments from IDN's usually negotiate prices and contract terms for all hospitals in the group, variability in prices between facilities within an IDN often results from errors at the wholesaler or other supplier. This situation is addressed in the described invention through the generation of a Price Parity Report 213. FIG. 8 shows an exemplary Price Parity Report 213 (as shown in FIG. 2), which is derived from client specific pricing reports for each NDC for several hospitals within an Integrated Delivery Network (“IDN”) of hospitals generated by the Pricing Module 211. This report also can be delivered via electronic methods such as e-mail or internet based dynamic interface as described above. The report 213 shown in FIG. 8 provides data on price variability, by product name 801 and NDC 802, within the same month 803 for facilities within an IDN 804. Separate reports can be prepared by class of trade and 340B/DSH status. The cost per unit purchased 805 minus the minimum unit cost available 806 is the difference per package 807 and is expressed as a percent difference 808. The savings opportunity for each purchase 809 is calculated by multiplying the units purchased 811 times the difference between the cost per unit purchased 805 and the minimum unit cost available 806. The total purchase amount is provided 810.

The Price Parity Report 213 shown in FIG. 8 can be submitted to wholesalers or other suppliers for credit for prior purchases and correction for future purchases. If separate contracts do exist within an IDN, the report quantifies potential opportunities to consolidate contracts.

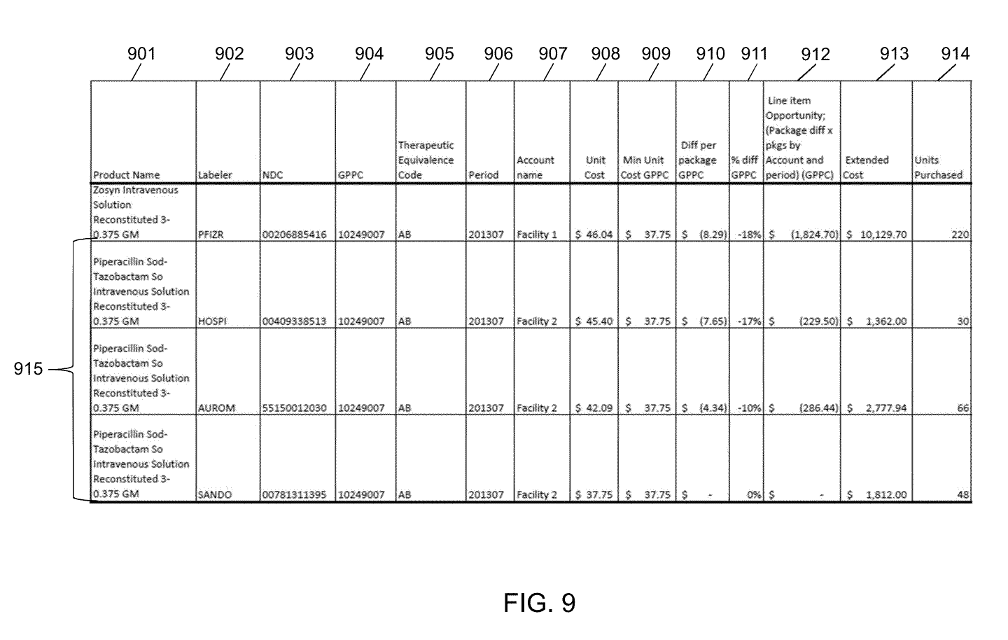

FIG. 9 shows an exemplary of client specific Purchase Opportunity Report 214 (as shown in FIG. 2), which can be delivered via electronic methods such as e-mail or internet or dynamic interface as described above. The report in FIG. 9 provides data regarding the product name 901, labeler 902, NDC 903, GPPC 904, therapeutic equivalence code 905, the purchase period 906, account name 907 and the extended cost (unit cost at the time of purchase×the number of units purchased at that cost) 913. For each item, the report includes a list of alternative lower cost products 915 that were available and purchased by a similarly situated organization, during the same time period. These products are equivalent based upon having the same GPPC and therapeutic equivalence rating or other similar metric that would deem the products to be equivalent. The unit cost 908 minus the minimum unit cost available in the same GPPC 909 is the difference per package GPPC 910 and is expressed as a percent difference in 911. The savings opportunity for each purchase 912 is calculated by multiplying the units purchased 814 times the difference per package GPPC 910.

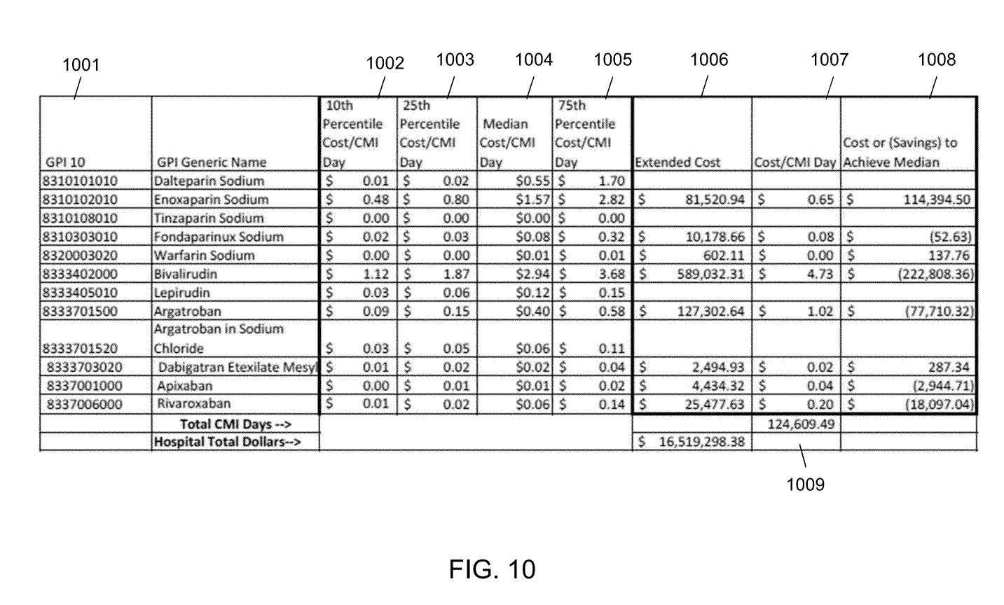

FIG. 10 illustrates a sample report generated as part of the utilization module 215 (as shown in FIG. 2; this data derives from utilization analysis 208). This figure depicts an example of a report of client specific inpatient purchases per GPI-10 1001 compared to the 10^{th} 1002 25^{th} 1003 50^{th} 1004 and 75^{th} percentiles 1005 of similarly situated organizations based upon bed size, patient acuity and associations with academic programs. Again illustrating the preparation and delivery capability of the present invention, report can be delivered via electronic methods such as e-mail or internet or dynamic interface described above. The report includes the calculation of the potential annual savings opportunity for the client, by inpatient GPI-10, if purchases were at the median for any given GPI-10. Conversely, items where the client's volume, acuity or financially adjusted inpatient purchases are below the median for similarly situated organizations, the difference, reported as “cost” that would be incurred is reported. The cost per CMI day 1007 is calculated for each GPI-10 by dividing the extended cost for the GPI-10 1006 by the total CMI adjusted days for the facility 1009.

The estimated savings expressed as a negative number in parentheses, is calculated according to the following formula: Savings Opportunity 1008=Client Inpatient Purchases per CMI Inpatient day 1007—the median purchase per CMI Inpatient Day 1004 for a similarly situated comparator group)×(CMI Inpatient Days 1009 for the measured time period). The above calculation is provided as an example of the savings opportunity for each GPI-10 item group. The invention performs the same calculations using the previously described volume and patient acuity metrics as denominators in the calculations. Other metrics and calculations may be developed based upon changes in market conditions or requests from clients.

Reports, such as the report shown in FIG. 10, may include, but are not limited to, a list that includes all GPI-10 items, the purchases by the client during the measured timeframe, the 10^{th}, 25^{th}, 50^{th} and 75^{th} percentiles and the potential for saving if the client purchases were at the 50^{th} percentile for similarly situated organizations.

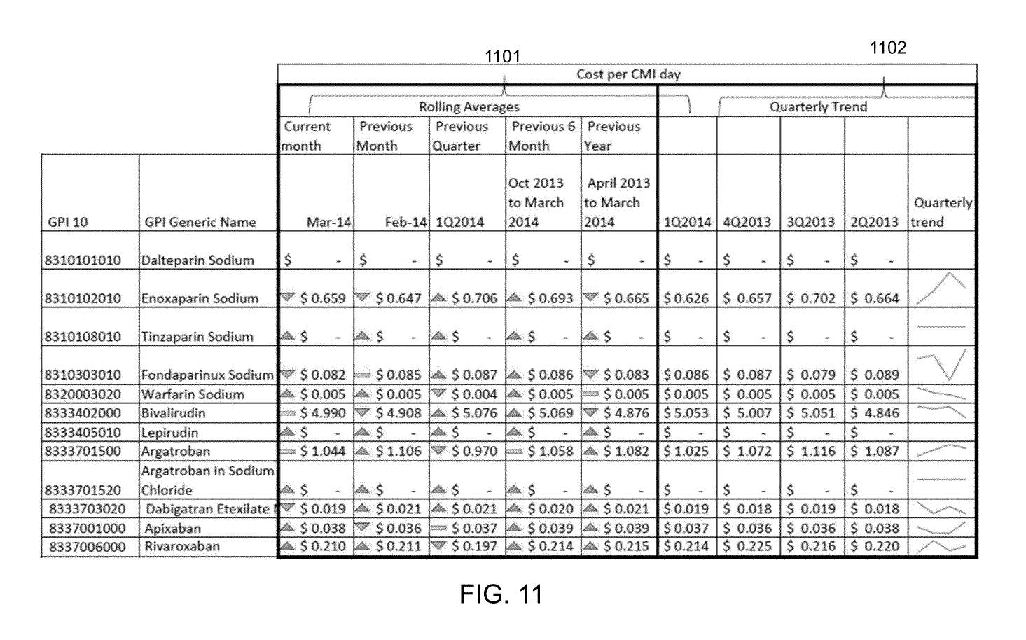

An example of the report generated by Longitudinal Tracking Module 217 shown in FIG. 2 is illustrated in FIG. 11. This report includes the preparation and delivery of a report that includes for each GPI-10 the inpatient purchases per CMI-Inpatient Day and CMI-Discharge for the previous month, quarter, six month period, year and/or other timeframes that may be requested or deemed meaningful. Rolling averages for CMI adjusted cost per day 1101 and quarterly averages for CMI adjusted cost per days 1102 are show to identify trends and track initiatives.

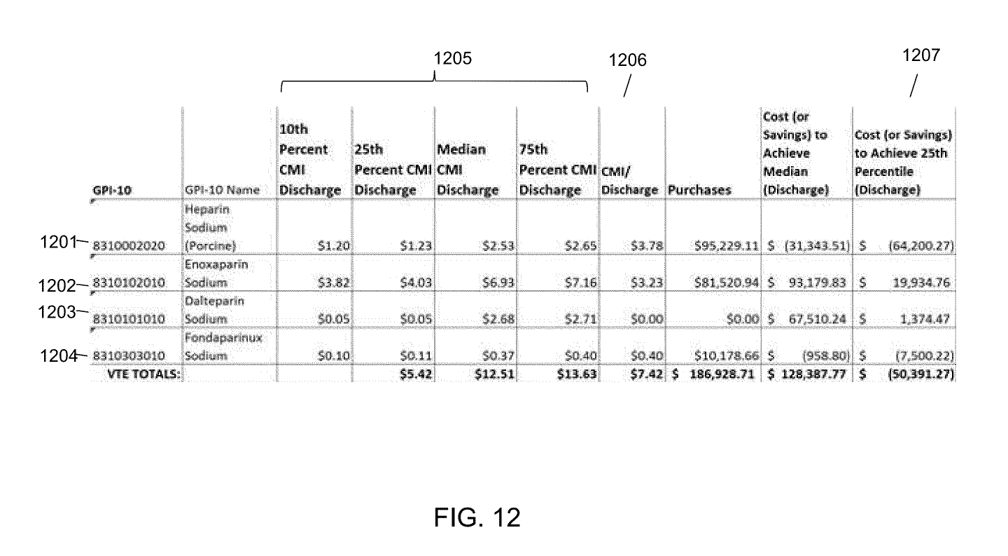

An example of the report generated by Therapeutic Grouping Module 218 in FIG. 2 is illustrated in FIG. 12. The prevention and/or treatment of certain medical conditions may involve using one drug or a combination of several drugs. Sometimes, the same medical condition may be prevented or treated with drugs that work differently from each other and are categorized in different therapeutic classes as defined by the ASHP. Therefore, for some therapies the grouping of drugs by therapeutic use is an effective method to help reduce the cost of preventing or treating certain conditions. The present invention involves establishing groups of drugs and establishing equivalent doses that are used for the prevention and treatment of various diseases. As an illustrative example, there are four medications with various standard daily doses that are administered as a subcutaneous (under the skin) injection for the prevention of venous thromboembolism (blood clots). While these four drugs have the same therapeutic use, they are not classified within the same ASHP therapeutic class. As shown in FIG. 12, these four drugs include: heparin 1201, which is administered at a dose of 5000 units (International Units), either two or three times per day; enoxaparin 1202, which is administered at a dose of 30 milligrams (mg) twice per day or 40 milligrams once per day; dalteparin 1203, which is administered at 2500 or 5000 units once per day; and fondaparinux 1204, which is administered at a dose of 2.5 milligrams once per day. In addition, depending on the desired effect of the drug, a different dose of each drug is required. For example, while 30 milligrams or 40 milligrams of enoxaparin is a common dose to prevent venous thromboembolism higher doses that are based on the body weight of the patient being treated are required to treat a blood clot that has already occurred. As these examples illustrate, simply grouping drugs by therapeutic class does not accurately reflect their various therapeutic uses.

The present invention corrects these problems with the current state by grouping drugs according to therapeutic use and where applicable specific doses of the drugs. The method includes establishing equivalent drugs, doses and number of doses per day for the prevention and treatment of select medical conditions based upon literature published evidence. The equivalent drugs, doses and number of doses per day are based upon an analysis of dosing, efficacy and safety data that is obtained from the manufacturer labeling and literature describing research and guidelines for the prevention and treatment of various medical conditions.

As shown in FIG. 12, the present invention includes a method of analysis of pharmaceutical purchase data and grouping by drug, dose per package unit, and therapeutic use. The inpatient purchases of a therapeutic group per client for a given unit of time are then adjusted for patient volumes including inpatient day, discharges, or other volume parameter that reflects the use of that drug at the doses included in the CMI/Discharge 1206.

FIG. 12 further shows that the report generated from Therapeutic Grouping Module 218 in FIG. 2 includes the merging of active client data and the calculation of statistical results including but not limited to the 10^{th}, 25^{th}, median or 50^{th} and 75^{th} percentiles 1205 for inpatient purchases for the therapeutic group adjusted for inpatient days, discharges, CMI or other parameters that are identified as reflecting the use volume of the therapeutic group. This report can also include client specific inpatient purchases of drugs and doses within a therapeutic group adjusted for volume compared to the 10^{th}, 25^{th}, 50^{th} and 75^{th} percentile 1205 for similarly situated organizations based upon bed size, patient acuity and associations with academic programs. The report includes the calculation of the potential annual savings opportunity for the client, by inpatient therapeutic group if their purchases were at the median for any given therapeutic group. Conversely, items where the client's volume, acuity or financially adjusted inpatient purchases are below the median for similarly situated organizations, the difference, reported as “cost” that would be incurred is reported at 1207.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method for comparing pharmaceutical prices and mediation utilization, the method comprising the steps of:
providing a first database containing client pharmaceutical wholesaler and non-wholesaler purchase data;
providing a second database containing pharmaceutical compendia information;
providing a third database containing client pharmaceutical contract information;
providing a fourth database containing client organizational profile information;
providing a fifth database containing client patient volume and acuity data; and
providing a processor in communication with the first, second, third, fourth, and fifth databases to execute the following steps of the method:
a. uploading the data and information from the databases into an input module that comprises the steps of (i) standardization of the data and information, (ii) performing a quality and verification check on the standardized data and information, (iii) merging the verified data and information with a standard pharmaceutical compendium in order to establish drug data elements and other product attributes, (iv) identifying an National Drug Code identifier from the drug compendia or assigning an internal item number for purchase data, (v) reviewing contract language for rebates, discounts and qualifying conditions, (v) merging aggregate client data from the first, third, fourth and fifth databases and aggregate compendia information from the second database into a standardized format; (vi) categorizing price file information, (vii) validating and performing a quality check on the price file information, and (viii) generating information resulting from these process steps;
b. processing the information generated from the input module in a processing module that (i) performs pricing and utilization analyses on the information, (ii) integrates the analyses to identify and quantify savings opportunities, and (iii) generating savings opportunities information;
c. outputting the savings opportunities information generated from the processing module to an output model that formats the savings opportunities information;
d. outputting the information formatted by the output module to a pricing module and a utilization module; and
e. generating at least one report from the pricing and utilization modules, with the report selected from the group consisting of a price comparison report, a price parity report, a purchase opportunity report, a utilization comparison report, a longitudinal tracking report, and a therapeutic grouping report.

2. The method of claim 1, wherein the data in the first database comprises (i) National Drug Code data; (ii) catalog number; (iii) product description, including drug name, strength, package size and units per package; (iv) package description; (v) units purchased net of returns during a designated reporting period; (vi) extended cost determined as units purchased×cost per unit at the time of purchase; (vii) last unit price paid; date of purchase; (viii) name of the contract under which the product was purchased; and (ix) name of the specific account within a facility purchasing the product.

3. The method of claim 1, wherein the information in the third database is selected from the group of contracts comprising (i) primary and secondary wholesaler distribution agreements; (ii) group purchasing organization agreements including all sub-agreements between the group purchasing organization and suppliers of pharmaceutical products on behalf of a client; (iii) direct contracts with manufacturers, suppliers and distributors of pharmaceutical products; (iv) contracts with manufacturers, suppliers and distributors of pharmaceutical products who provide product on consignment; and (v) direct contracts with manufacturers, suppliers and distributors of other products that are related to pharmaceuticals.

4. The method of claim 1, wherein the information in the third database comprises (i) the beginning and end date of contract; (ii) the National Drug Code if available; (iii) catalog or item number from supplier if no National Drug Code is available; (iv) product description, including package sizes and units of measure; (v) cost per unit for each contract tier if applicable; (vi) volume or market share requirements for each contract tier; (vii) discounts and/or rebates associated with each contract tier; and (viii) contract name and/or number

5. The method of claim 1, wherein the information in the fourth database is used to accurately segment facilities based on assessment of bed size, class of trade, eligibility for 340B pricing and clinical services offered.

6. The method of claim 1, wherein the data in the fifth database comprises (i) patient days, (ii) discharges, (iii) observation days, (iv) newborn days, (v) mean length of stay, (vi) case mix index, (vii) total gross revenue, and (viii) inpatient drug expense.

7. The method of claim 1, wherein the at least one report is delivered by electronic means.

8. The method of claim 1, wherein the at least one report is provided in a standard or customized version.

9. The method of claim 8, wherein customized versions of the at least one report can be accessed and created by a user using a web interface or other database interface tool.
